(19) United States
(12) Patent Application Publication
(10) Pub. No.: US 2024/0339732 A1
(43) Pub. Date: Oct. 10, 2024

(54) BUS BAR MODULE

(71) Applicant: YAZAKI CORPORATION, Tokyo (JP)

(72) Inventors: Mariko NAKAGAWA, Shizuoka (JP); Hirotaka Mukasa, Shizuoka (JP); Tatsuya Oga, Shizuoka (JP)

(73) Assignee: YAZAKI CORPORATION, Tokyo (JP)

(21) Appl. No.: 18/624,571

(22) Filed: Apr. 2, 2024

(30) Foreign Application Priority Data
Apr. 5, 2023 (JP) 2023-061267

(51) Int. Cl. H01M 50/505; H01M 50/588; H01M 50/591

(52) U.S. Cl. CPC H01M 50/505; H01M 50/588; H01M 50/591

(57) ABSTRACT

A bus bar module includes a bus bar that connects one terminal of a first single battery and one terminal of a second single battery which project in parallel with each other; and a bus bar case having insulating properties that includes a housing part which houses the bus bar and a cover which is mounted to the housing part. The housing part includes a side wall part having a frame shape that surrounds the bus bar from a direction perpendicular to a connection direction of the terminals, and a support part that supports the bus bar from a side of a first opening facing the first single battery or the second single battery. The cover includes a cover body that covers a second opening opposite to the first opening, and a projecting part that projects from the cover body toward the first opening and contacts the bus bar.

### CROSS-REFERENCE TO RELATED APPLICATIONS

The present application is based on, and claims priority from the prior Japanese Patent Application No. 2023-061267, filed on Apr. 5, 2023, the entire contents of which are incorporated herein by reference.

### TECHNICAL FIELD

The present disclosure relates to a bus bar module.

### BACKGROUND

Conventionally, a battery pack as a driving source is mounted in a vehicle such as an electric vehicle or a hybrid vehicle. There is a case where a bus bar module is employed which electrically connects each single battery in the battery pack. As a technology relating to a bus bar module, JP 2012-227004 A discloses a battery connection assembly that connects each of a plurality of single batteries in a battery module. The battery connection assembly includes a bus bar that electrically connects a positive electrode terminal of one of adjacent single batteries and a negative electrode terminal of the other of adjacent single batteries, and an insulating member that holds the bus bar therein.

The insulating member disclosed in JP 2012-227004 A has a locking claw which is disposed at a side wall of a housing part for housing the bus bar, and is elastically deformable in a thickness direction of the side wall while projecting in the housing part. When the bus bar is attached to the housing part, the locking claw is elastically deformed by being abutted to the bus bar, and then a shape thereof returns to an original shape when the bus bar passes over the locking claw. Eventually, a portion of the bus bar is placed on a placement part, and the bus bar is held in the housing part due to an end edge of the bus bar engaging with the locking claw.

### SUMMARY OF THE INVENTION

In the insulating member disclosed in JP 2012-227004 A, in order to allow the elastic deformation of the locking claw required for attachment of the bus bar, it is necessary to ensure the length of a longitudinal portion of the locking claw along an attachment direction to a certain extent. Therefore, the height of the side wall along the attachment direction of the bus bar is also required by the amount that the length of the locking claw is ensured, and this may inhibit a decrease in the height of the housing part as a portion of the insulating member and consequently inhibit reduction in the size of the battery connection assembly.

The present disclosure has been devised in view of the problems of the related art. An object of the present disclosure is to provide a bus bar module that is advantageous for reducing the height of a housing part for housing a bus bar.

An aspect of the present disclosure provides a bus bar module that electrically connects a first single battery having a positive electrode terminal and a negative electrode terminal as a pair of terminals and a second single battery having a positive electrode terminal and a negative electrode terminal as a pair of terminals, the bus bar module including: a bus bar that connects one of the pair of the terminals of the first single battery and one of the pair of the terminals of the second single battery which project in parallel with each other; and a bus bar case having insulating properties that includes a housing part which houses the bus bar and a cover which is mounted to the housing part, in which the housing part includes a side wall part having a frame shape that surrounds the bus bar from a direction perpendicular to a connection direction of the terminals, and a support part that supports the bus bar from a side of a first opening facing the first single battery or the second single battery in the side wall part, and the cover includes a cover body that covers a second opening opposite to the first opening in the side wall part, and a projecting part that projects from the cover body toward the first opening and contacts the bus bar.

According to the present disclosure, it is possible to provide a bus bar module that is advantageous for reducing the height of a housing part for housing a bus bar

### BRIEF DESCRIPTION OF DRAWINGS

FIG. 1A is a perspective view of a bus bar module according to an embodiment before mounting a cover.

FIG. 1B is a perspective view of a bus bar module according to an embodiment after mounting the cover.

FIG. 2 is a perspective view illustrating a first example of a bus bar case.

FIG. 3 is a perspective view illustrating a second example of a bus bar case.

FIG. 4 is a perspective view illustrating a third example of a bus bar case.

FIG. 5 is a perspective view illustrating a fourth example of a bus bar case.

### DETAILED DESCRIPTION OF THE INVENTION

A bus bar module according to an embodiment will be described in detail below with reference to the drawings. The dimensional ratios of the drawings are exaggerated for convenience of explanation and may differ from the actual ratio.

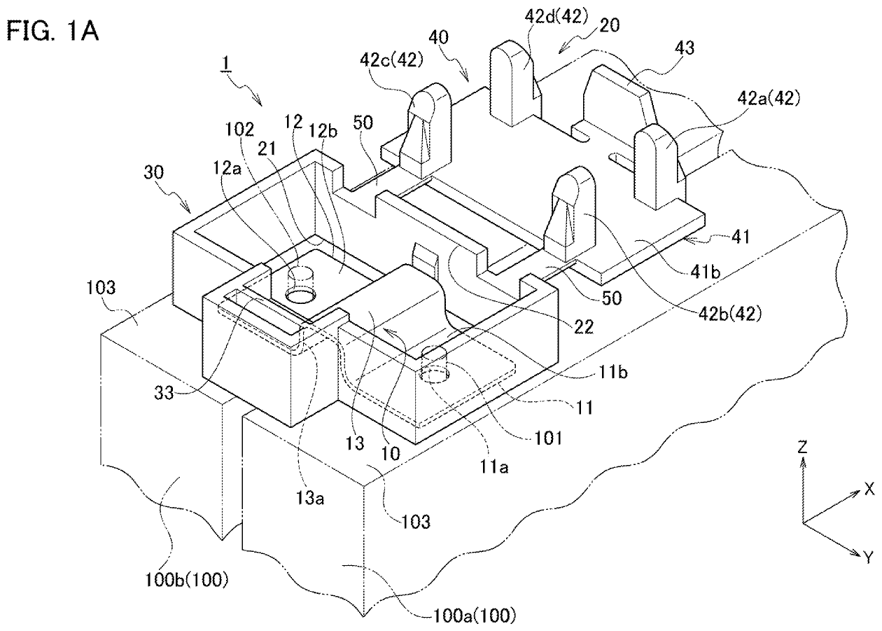

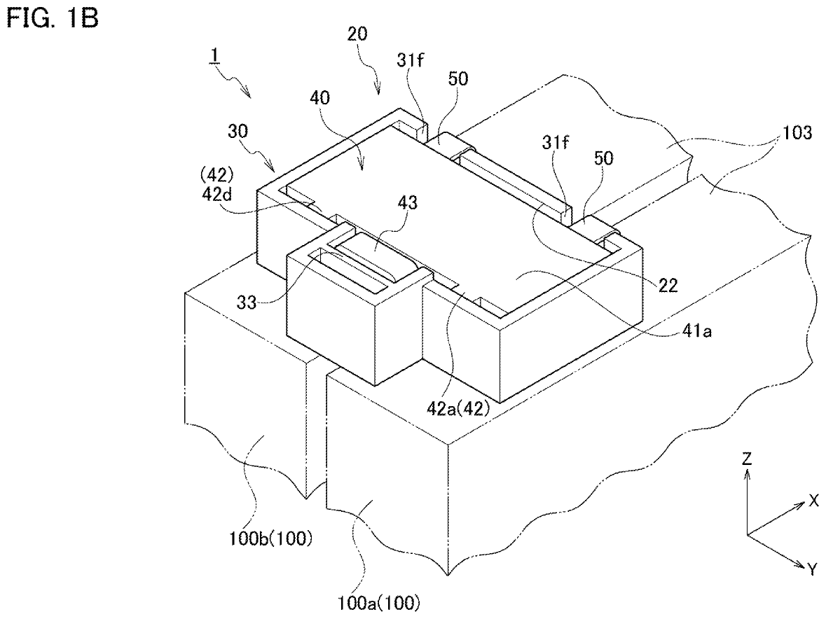

FIGS. 1A and 1B are perspective views of a bus bar module 1 according to an embodiment. FIG. 1A illustrates a bus bar module 1 in a state before a cover 40 is mounted to a housing part 30 in a bus bar case 20. FIG. 1B illustrates a bus bar module 1 in a state after the cover 40 is mounted to the housing part 30. Hereinafter, a state when the cover 40 is mounted to the housing part 30 will be simply expressed as “when the cover is mounted”.

Generally, to a vehicle such as an electric vehicle or a hybrid vehicle, a battery pack as a driving source having a plurality of single batteries 100 is mounted. The bus bar module 1 is used for this kind of battery pack and electrically connects the single batteries 100 to each other. The battery pack is sometimes referred to as a pack having batteries. A single battery is sometimes referred to as a single cell or a cell.

Hereinafter, as an example, the bus bar module 1 electrically connects two single batteries 100, that are a first single battery 100a and a second single battery 100b, which are provided in a virtual battery pack, as illustrated by two-dot chain lines in FIGS. 1A and 1B. It is assumed that the first single battery 100a and the second single battery 100b have the same shape and configuration. A schematic shape of each single battery 100 is a rectangular parallelepiped shape. On one end surface of each single battery 100, a positive electrode terminal 101 and a negative electrode terminal 102 are disposed which project in the same direction while being separated from each other. Each of the positive electrode terminal 101 and the negative electrode terminal 102 has a round rod shape, and a screw thread is formed at least at a tip thereof.

With reference to a shape or structure of each single battery 100, each direction is defined as follows. A Z direction is along a projection direction of the positive electrode terminal 101 and the negative electrode terminal 102. Both an X direction and a Y direction are perpendicular to the Z direction and are perpendicular to each other. The X direction is along a direction in which the positive electrode terminal 101 and the negative electrode terminal 102 of each single battery 100 are in line with each other. Each single battery 100 can be regarded to have a flat rectangular parallelepiped shape with an XZ plane as a principal plane and the Y direction as a thickness direction. Hereinafter, among four end surfaces of each single battery 100, an end surface which is parallel to an XY plane and has the positive electrode terminal 101 and the negative electrode terminal 102 thereon is defined as a connection surface 103. In the connection surface 103, the positive electrode terminal 101 is disposed in one end region in the X direction, and the negative electrode terminal 102 is disposed in the other end region in the X direction. Further, the Y direction corresponds to a direction in which the plurality of single batteries 100 of the battery pack are arranged. In the present embodiment, the first single battery 100a and the second single battery 100b are arranged such that the positive electrode terminal 101 and negative electrode terminal 102 thereof are opposite to each other in the X direction. In this case, the positive electrode terminal 101 of the first single battery 100a and the negative electrode terminal 102 of the second single battery 100b and, a negative electrode terminal 102 (not illustrated) of the first single battery 100a and a positive electrode terminal 101 (not illustrated) of the second single battery 100b face each other in close proximity along the Y direction.

The bus bar module 1 connects the first single battery 100a and the second single battery 100b in series by electrically connecting the positive electrode terminal 101 of the first single battery 100a and the negative electrode terminal 102 of the second single battery 100b. The bus bar module 1 includes a bus bar 10, the bus bar case 20, and a voltage detection circuit (not illustrated).

The bus bar 10 is a conductive member made of metal and connects the positive electrode terminal 101 of the first single battery 100a and the negative electrode terminal 102 of the second single battery 100b, which project in parallel with each other. The bus bar 10 can be formed by press processing a long plate-like metal material. In the present embodiment, the bus bar 10 includes a first connection part 11, a second connection part 12, and an engagement part 13.

The first connection part 11 is a plate-like part for connecting the positive electrode terminal 101 of the first single battery 100a. The first connection part 11 may have a first through hole 11a passing through in a thickness direction, for example. A portion of the positive electrode terminal 101 of the first single battery 100a passes through the first through hole 11a when the bus bar 10 is attached. Similarly, the second connection part 12 is a plate-like part for connecting the negative electrode terminal 102 of the second single battery 100b. The second connection part 12 may have a second through hole 12a passing through in the thickness direction, for example. A portion of the negative electrode terminal 102 of the second single battery 100b passes through the second through hole 12a when the bus bar 10 is attached. In the present embodiment, as viewed in the Z direction, the bus bar 10 has a rectangular shape with the Y direction as a longitudinal direction. The thickness direction of the first connection part 11 and the second connection part 12 is along the Z direction. Further, the first through hole 11a and the second through hole 12a are separated from each other in the Y direction as a pair of through holes in one bus bar 10.

Opening shapes of the first through hole 11a and the second through hole 12a may be circular in accordance with axial shapes of the positive electrode terminal 101 and the negative electrode terminal 102. In this case, a pitch connecting axial centers of the first through hole 11a and the second through hole 12a is approximately equal to a pitch connecting axial centers of the positive electrode terminal 101 of the first single battery 100a and the negative electrode terminal 102 of the second single battery 100b.

The engagement part 13 is disposed so as to be across between the first connection part 11 and the second connection part 12, and is supported by a support part 32 of the bus bar case 20. In the present embodiment, the engagement part 13 is disposed in the middle of the bus bar 10 in the Y direction, and is a bent part having a convex shape with the outside projecting in the Z direction such that a groove 13a along the X direction is formed therein.

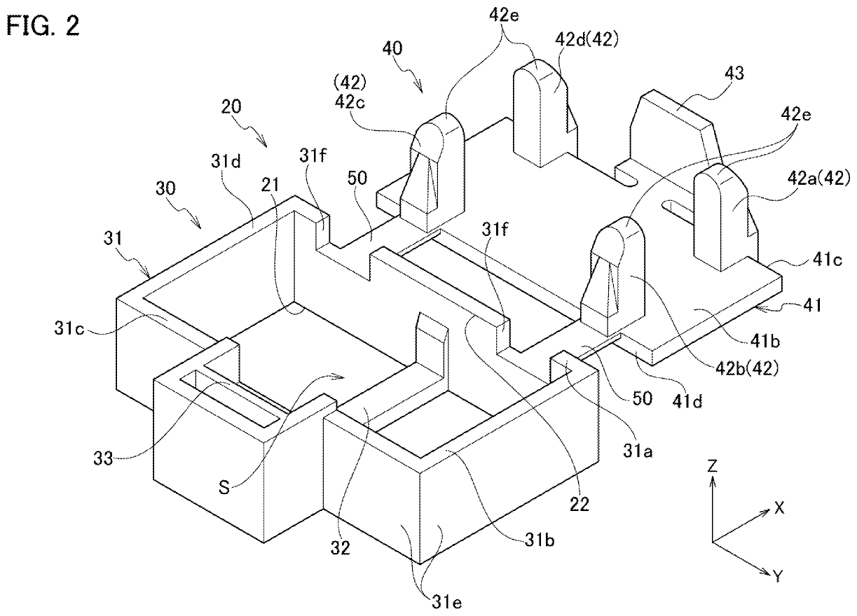

FIG. 2 is a perspective view illustrating a first example of the bus bar case 20. FIG. 2 illustrates the bus bar case 20 before the cover 40 is mounted to the housing part 30, similar to that illustrated in FIG. 1A.

The bus bar case 20 is an insulating member made of synthetic resin, for example, and accommodates the bus bar 10 connected to the positive electrode terminal 101 of the first single battery 100a and the negative electrode terminal 102 of the second single battery 100b. The bus bar case 20 can be formed by performing injection molding using a mold tool. In the present embodiment, the bus bar case 20 has the housing part 30, the cover 40, and hinge parts 50 integrally.

The housing part 30 houses the bus bar 10. The housing part 30 has a side wall part 31, the support part 32, and a locked part 33.

The side wall part 31 has a frame shape surrounding the bus bar 10 from the X direction or the Y direction which is perpendicular to the Z direction as a direction in which the positive electrode terminal 101 and the negative electrode terminal 102 are connected to the bus bar 10. In the present embodiment, the side wall part 31 is a rectangular frame of which outer periphery and inner periphery have a rectangular shape with the Y direction as a longitudinal direction as viewed in the Z direction in accordance with a rectangular shape of the bus bar 10 as viewed in the Z direction. Specifically, the side wall part 31 has a first side wall 31a, a second side wall 31b, a third side wall 31c, and a fourth side wall 31d. The first side wall 31a, the second side wall 31b, the third side wall 31c, and the fourth side wall 31d are annularly continuous in this order. The first side wall 31a and the third side wall 31c face each other in the X direction. The second side wall 31b and the fourth side wall 31d face each other in the Y direction. In this case, a housing space S passing through along the Z direction is formed inside the side wall part 31.

When the bus bar module 1 is connected to the first single battery 100a and the second single battery 100b, a side facing the first single battery 100a or the second single battery 100b is defined as a “down” side, and a side opposite to the down side in the Z direction is defined as an “up” side. Hereinafter, in the side wall part 31, an opening on the down side communicating with the housing space S is referred to as a first opening 21, and an opening on the up side communicating with the housing space S is referred to as a second opening 22.

Length dimensions of the first side wall 31a and the third side wall 31c in the Y direction and length dimensions of the second side wall 31b and the fourth side wall 31d in the X direction are set such that, as viewed in the Z direction, the inner periphery of the side wall part 31 is larger than the outer periphery of the bus bar 10. The height dimension of the side wall part 31 in the Z direction is set so as to be higher than upper ends of the positive electrode terminal 101 and the negative electrode terminal 102 when the bus bar module 1 is connected to the first single battery 100a and the second single battery 100b.

The support part 32 supports the bus bar 10 from the first opening 21 side in the housing space S. In the present embodiment, the support part 32 is a rod-shaped part that extends along the X direction such that one end thereof is continuous with the first side wall 31a and the other end thereof is continuous with the third side wall 31c. Further, the support part 32 is located at the vicinity of the first opening 21 in the Z direction, and is located in the middle of the housing space S in the Y direction. Although there are no particular limitations on the rod shape of the support part 32, it is sufficient if a shape allows the support part to engage with the groove 13a of the engagement part 13 disposed in the bus bar 10.

The locked part 33 is installed on an outer surface 31e side of the side wall part 31, and engages with a locking part 43 when the cover is mounted. In the present embodiment, the locked part 33 is installed at a portion of the outer surface 31e of the third side wall 31c.

The cover 40 is mounted to the housing part 30. The cover 40 has a cover body 41, projecting parts 42, and the locking part 43.

The cover body 41 is a plate body covering the second opening 22 in the side wall part 31. In the present embodiment, since the side wall part 31 is a rectangular frame, a shape of the cover body 41 as viewed in the Z direction is a rectangular shape which is approximately the same as a shape of the second opening 22 and is smaller than the size of the second opening 22. The cover body 41 has an outer surface 41a and an inner surface 41b, which are a front surface and a back surface opposite to each other. The outer surface 41a faces the outside when the cover is mounted. The inner surface 41b faces the housing space S when the cover is mounted. Among four end edges of the cover body 41, one end edge along the Y direction is defined as a first end edge 41c, and the other end edge along the Y direction is defined as a second end edge 41d.

The projecting parts 42 contact the bus bar 10 in the housing space S when the cover is mounted. The projecting parts 42 are columnar parts projecting in a normal direction from the inner surface 41b such that an axial direction thereof is along the Z direction when the cover is mounted. In other words, the projecting parts 42 have a shape projecting from the cover body 41 toward the first opening 21 when the cover is mounted. In the housing space S, the bus bar 10 is connected to the positive electrode terminal 101 of the first single battery 100a and the negative electrode terminal 102 of the second single battery 100b. Therefore, the projecting parts 42 contact a remaining surface of a surface on the bus bar 10, the remaining surface being obtained by avoiding a portion where the positive electrode terminal 101 is bolt fastened in the first connection part 11 and a portion where the negative electrode terminal 102 is bolt fastened in the second connection part 12.

In the present embodiment, as an example, there are a total of four projecting parts 42, that are a first projecting part 42a, a second projecting part 42b, a third projecting part 42c, and a fourth projecting part 42d. The first projecting part 42a and the fourth projecting part 42d are aligned with each other along the first end edge 41c and at an interval at which contact with the engagement part 13 of the bus bar 10 can be avoided when the cover is mounted. The second projecting part 42b and the third projecting part 42c are aligned with each other along the second end edge 41d and at an interval at which contact with the engagement part 13 of the bus bar 10 can be avoided when the cover is mounted.

The first projecting part 42a and the second projecting part 42b are aligned with each other in the X direction and at an interval at which contact with a portion where the positive electrode terminal 101 is bolt fastened in the first connection part 11 can be avoided when the cover is mounted. That is, tip parts 42e of the first projecting part 42a and the second projecting part 42b press different positions of a first connection surface 11b other than the portion where the positive electrode terminal 101 is bolt fastened in the first connection part 11 when the cover is mounted.

The third projecting part 42c and the fourth projecting part 42d are aligned with each other in the X direction and at an interval at which contact with a portion where the negative electrode terminal 102 is bolt fastened in the second connection part 12 can be avoided when the cover is mounted. That is, tip parts 42e of the third projecting part 42c and the fourth projecting part 42d press different positons of a second connection surface 12b other than the portion where the negative electrode terminal 102 is bolt fastened in the second connection part 12 when the cover is mounted.

As illustrated in FIG. 2 and the like, a shape of a tip part 42e of each projecting part 42 may be curved in order to easily respond to the deviation of a relative position between the bus bar 10 and the bus bar case 20.

The locking part 43 is engaged with the locked part 33 disposed in advance in the housing part 30 when the cover is mounted. In the present embodiment, the locked part 33 is installed at a portion of the outer surface 31e of the third side wall 31c of the housing part 30, and therefore the locking part 43 is installed at a portion of the first end edge 41c of the cover body 41. The locked part 33 and the locking part 43 constitute a locking mechanism in pairs, but a specific configuration is not particularly limited.

The hinge parts 50 are deformable thin plate parts connecting the housing part 30 and the cover 40. In the present embodiment, before the cover 40 is mounted to the housing part 30, there are two hinge parts 50 which are disposed in parallel so as to be separated from each other in the Y direction while extending along the X direction. One end of each hinge part 50 is continuous with the outer surface 31e on the first side wall 31a of the side wall part 31. The other end opposite to the one end of each hinge part 50 is continuous with the second end edge 41d of the cover body 41. When the cover is mounted, the hinge parts 50 are bent, and the locking part 43 is locked with the locked part 33, and therefore the cover 40 is held by the housing part 30 while covering the second opening 22.

The first side wall 31a may have two cutout parts 31f which face the second opening 22, and house a portion of the hinge parts 50 bent when the cover is mounted. In this case, one end of each hinge part 50 is continuous with a bottom of each cutout part 31f. With this kind of configuration, when the cover is mounted, as illustrated in FIG. 1B, the entire cover body 41 can be housed in the housing space S such that the outer surface 41a of the cover body 41 approximately matches an opening end on the second opening 22 side of the housing part 30.

The voltage detection circuit is a wiring material wired in the bus bar module 1, is electrically connected to a positive electrode terminal 101 and a negative electrode terminal 102 of each single battery 100 connected in series by the bus bar 10, and detects a voltage of each single battery 100. The voltage detection circuit is connected to a controller (not illustrated), and a state of each single battery 100 is controlled due to the voltage detection circuit transmitting detection information to the controller.

Next, how the bus bar module 1 is attached to the single batteries 100 will be described.

First, as illustrated in FIG. 1A, it is assumed that the first single battery 100a and the second single battery 100b are arranged in advance with the Y direction as an alignment direction. An operator mounts the side wall part 31 on a connection surface 103 of each of the first single battery 100a and the second single battery 100b while allowing the positive electrode terminal 101 of the first single battery 100a and the negative electrode terminal 102 of the second single battery 100b to enter the housing space S through the first opening 21 of the housing part 30.

Next, the operator houses the bus bar 10 in the housing space S through the second opening 22 of the housing part 30 such that the groove 13a disposed in the bus bar 10 engages with the support part 32 of the housing part 30. At this time, the operator causes the positive electrode terminal 101 of the first single battery 100a to pass through the first through hole 11a provided in the first connection part 11 of the bus bar 10. At the same time, the operator causes the negative electrode terminal 102 of the second single battery 100b to pass through the second through hole 12a disposed in the second connection part 12 of the bus bar 10. Thereafter, the operator attaches the first connection part 11 to the positive electrode terminal 101, and also attaches the second connection part 12 to the negative electrode terminal 102 by means of bolt fastening using nuts (not illustrated). FIG. 1A illustrates the appearance of the bus bar 10 and the bus bar case 20 at this stage.

Then, the operator causes the cover 40 to be mounted to the housing part 30 while bending the hinge parts 50 of the bus bar case 20. FIG. 1B illustrates the appearance of the bus bar case 20 at this stage. The cover body 41 is in a locked state while covering the second opening 22 due to the locking part 43 of the cover 40 being locked with the locked part 33 of the housing part 30. At this time, the tip parts 42e of the plurality of projecting parts 42 projecting from the inner surface 41b of the cover body 41 come into contact with the bus bar 10, and therefore each projecting part 42 presses the bus bar 10 in a direction toward a connection surface 103 of each single battery 100. In the present embodiment, the first projecting part 42a and the second projecting part 42b press the first connection surface 11b on the first connection part 11. Meanwhile, the third projecting part 42c and the fourth projecting part 42d press the second connection surface 12b on the second connection part 12.

Meanwhile, the bus bar 10 is supported by the support part 32 of the housing part 30 in a direction opposite to a direction in which each projecting part 42 presses the first connection surface 11b and the second connection surface 12b. Therefore, the bus bar 10 is held by the bus bar case 20 in such a manner that the entire bus bar is sandwiched between the support part 32 and the plurality of projecting parts 42 along the Z direction.

The Z direction when the cover is mounted is defined as a height direction of the bus bar 10 and the bus bar case 20. In this case, it is desirable that the height dimension of each projecting part 42 is set to the extent that a pressing force capable of holding the bus bar 10 can be applied when a positon of the outer surface 41a of the cover body 41 matches a position of an opening end on the second opening 22 side of the housing part 30 in the height direction when the cover is mounted.

Next, effects of the bus bar module 1 will be described.

First, the bus bar module 1 electrically connects the first single battery 100a and the second single battery 100b, each of which has a positive electrode terminal 101 and a negative electrode terminal 102 as a pair of terminals. The bus bar module 1 has the bus bar 10 connecting one terminal of the first single battery 100a and one terminal of the second single battery 100b which project in parallel with each other. Further, the bus bar module 1 includes the insulating bus bar case 20 having the housing part 30 for housing the bus bar 10 and the cover 40 mounted to the housing part 30. The housing part 30 includes the frame-shaped side wall part 31 surrounding the bus bar 10 from a direction perpendicular to a direction in which terminals are connected, and the support part 32 for supporting the bus bar 10 from the first opening 21 side facing the first single battery 100a or the second single battery 100b in the side wall part 31. The cover 40 includes the cover body 41 covering the second opening 22 opposite to the first opening 21 in the side wall part 31, and the projecting part 42 projecting from the cover body 41 toward the first opening 21 and contacting the bus bar 10.

In the exemplification above using each drawing, a direction in which the positive electrode terminal 101 and the negative electrode terminal 102 are connected to the bus bar 10 corresponds to a Z direction.

According to the configuration of the bus bar module 1, the bus bar 10 is connected to the first single battery 100a and the second single battery 100b in a state where the entire bus bar is covered by the insulating bus bar case 20. Therefore, the bus bar 10 itself, a connection portion between the bus bar 10, and the positive electrode terminal 101 or the negative electrode terminal 102, or the like is protected from the outside. It is possible to prevent a situation in which due to a tool used by an operator accidentally contacting the positive electrode terminal 101 and the negative electrode terminal 102, the positive electrode terminal 101 and the negative electrode terminal 102 are short-circuited via the tool, for example.

In addition, according to the configuration of the bus bar module 1, the bus bar case 20 holds the bus bar 10 in such a manner that the entire bus bar is sandwiched between the support part 32, which is a portion of the housing part 30, and the projecting parts 42, which are a portion of the cover 40 along a direction in which terminals are connected. If the direction in which terminals are connected is defined as a height direction, a height position of the cover 40 of the bus bar case 20 can be set to be low by setting the height dimension of the projecting parts 42 to be as low as possible while considering the height of a terminal such as the positive electrode terminal 101. Therefore, the height of the side wall part 31 to which the cover 40 is directly mounted, that is, the height of the housing part 30 can be further reduced.

As a comparative example, it is assumed that a bus bar case, which does not have the projecting parts 42 as described above, holds a bus bar using a locking claw disposed at a side wall part constituting a housing part. In this case, unlike the present embodiment, all of holding mechanisms of the bus bar are present in the housing part. In order to allow the elastic deformation of the locking claw required for attachment of the bus bar, it is necessary to ensure the length of a longitudinal portion of the locking claw along an attachment direction, that is, the height direction to a certain extent. The required length of the locking claw is not related to the height of a terminal such as the positive electrode terminal 101. Therefore, even if the height of the side wall part can be set to be lower based on the height of a terminal such as the positive electrode terminal 101, there is a possibility that the height of the side wall part may not be set lower due to the necessity of ensuring the length of the locking claw.

As described above, according to the present embodiment, it is possible to provide the bus bar module 1 which is advantageous for reducing the height of the housing part 30 for housing the bus bar 10.

In addition, according to the present embodiment, the side wall part 31 of the housing part 30 does not have the locking claw as described in the above comparative example. Therefore, before the cover 40 is mounted to the housing part 30, as viewed in the Z direction from above, the housing space S which is the interior of the housing part 30 becomes wider by the amount that the locking claw is not present. Therefore, it is possible to reduce in advance portions that can interfere when the positive electrode terminal 101 or the negative electrode terminal 102 is connected to the first connection part 11 or the second connection part 12 of the bus bar 10 by means of bolt fastening or the like, for example.

In the above description with reference to each drawing, it is assumed that the first projecting part 42a, the second projecting part 42b, the third projecting part 42c, and the fourth projecting part 42d are present as the projecting parts 42. Since this kind of plurality of projecting parts 42 can sandwich the bus bar 10 with the support part 32 in a balanced manner, the reliability of holding the bus bar 10 can be enhanced. Meanwhile, depending on the size or detailed shape of the bus bar 10 or the bus bar case 20, or projecting positions of the projecting parts 42 in the cover body 41, there is a possibility that only one projecting part 42 may be present in the bus bar case 20.

Further, in the above description, it is assumed that the positive electrode terminal 101 and the negative electrode terminal 102 are connected to the bus bar 10 by means of bolt fastening using nuts or the like. However, this bolt fastening is merely an exemplification, and a terminal such as the positive electrode terminal 101 may be connected to the bus bar 10 by means of laser welding or the like, for example. The fact that there is no locking claw at the side wall part 31 and the housing space S before mounting the cover can be made wider is also advantageous in that it is possible to reduce portions that can interfere when a terminal such as the positive electrode terminal 101 is joined to the bus bar 10 by means of laser welding.

Meanwhile, the bus bar case 20 may be deformed as follows.

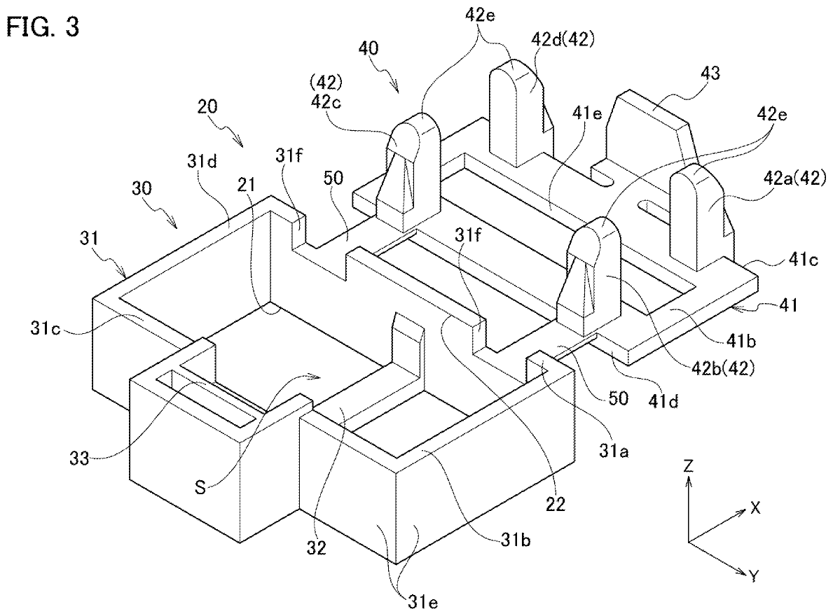

FIG. 3 is a perspective view illustrating a second example of a bus bar case 20. In the bus bar case 20 of the second example, the same parts as those of the bus bar case 20 of the first example illustrated in FIG. 2 are denoted by the same reference numerals, and a description thereof will be omitted.

In the second example of the bus bar case 20, a cover body 41 has a through hole 41e. Since projecting parts 42 projecting from the cover body 41 are disposed on a cover 40, the through hole 41e is formed in a region of the cover body 41 obtained by avoiding installation positions of the projecting parts 42. In an exemplification of the present embodiment, a first projecting part 42a, a second projecting part 42b, a third projecting part 42c, and a fourth projecting part 42d are present as the projecting parts 42. In this case, an opening shape of the through hole 41e may be a rectangular shape with the Y direction as a longitudinal direction. Further, the through hole 41e may be formed to extend in both of a region between the first projecting part 42a and the second projecting part 42b, and a region between the third projecting part 42c and the fourth projecting part 42d. Due to the through hole 41e having this kind of shape, a connection portion between a bus bar 10 and a terminal such as a positive electrode terminal 101 in a housing space S is visible from the outside through the through hole 41e even when the cover is mounted.

In this way, in a bus bar module 1, the cover body 41 may have the through hole 41e.

According to the bus bar module 1, even when the cover is mounted, an operator can visually recognize the inside of the housing space S from the outside through the through hole 41e, and can perform bolt fastening or laser welding for connecting the bus bar 10 to a terminal such as the positive electrode terminal 101, for example.

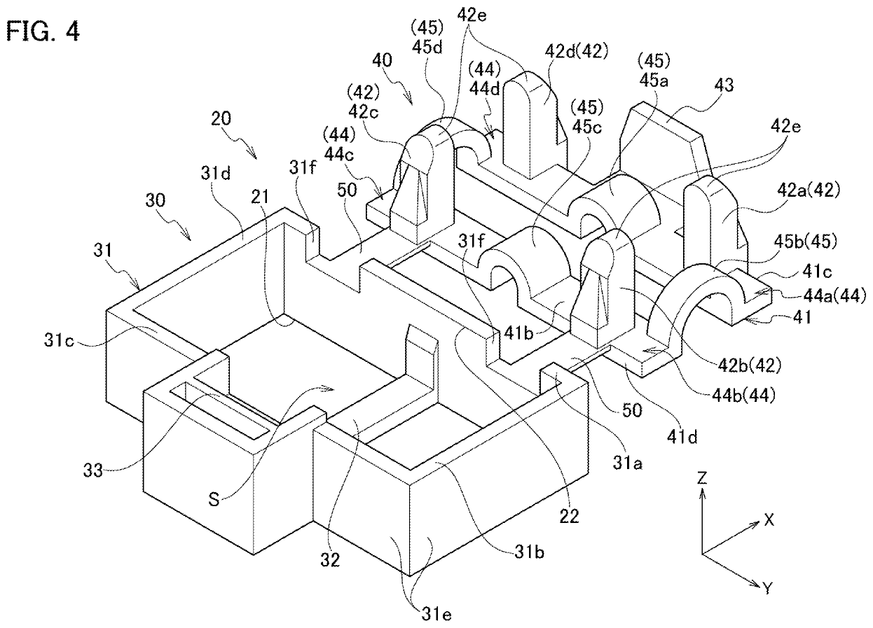

FIG. 4 is a perspective view illustrating a third example of a bus bar case 20. In the bus bar case 20 according to the third example, the same parts as those of the bus bar case 20 according to the first example illustrated in FIG. 2 are denoted by the same reference numerals, and a description thereof will be omitted.

In the first example and the second example of the bus bar case 20, the cover body 41 is one plate body, while in the third example of the bus bar case 20, a cover body 41 is divided into a plurality of pieces. Specifically, the cover body 41 has a plurality of flat plate parts 44 and a plurality of elastic parts 45.

In the present embodiment, the number of flat plate parts 44 is four in correspondence with four projecting parts 42. The four flat plate parts 44, that is, a first flat plate part 44a, a second flat plate part 44b, a third flat plate part 44c, and fourth flat plate part 44d, are arranged in a planar direction. The first flat plate part 44a supports a first projecting part 42a. The second flat plate part 44b supports a second projecting part 42b. The third flat plate part 44c supports a third projecting part 42c. The fourth flat plate part 44d supports a fourth projecting part 42d. The first flat plate part 44a and the second flat plate part 44b are separated from each other in the X direction. Similarly, the third flat plate part 44c and the fourth flat plate part 44d are separated from each other in the X direction. The first flat plate part 44a and the fourth flat plate part 44d are separated from each other at least partially in the Y direction. Similarly, the second flat plate part 44b and the third flat plate part 44c are separated from each other in the Y direction.

In the present embodiment, the number of elastic parts 45 is four in correspondence with each arrangement of the four flat plate parts 44. The four elastic parts 45 are a first elastic part 45a, a second elastic part 45b, a third elastic part 45c, and a fourth elastic part 45d, and each of the parts connects adjacent flat plate parts 44. The first elastic part 45a connects the first flat plate part 44a and the fourth flat plate part 44d in the Y direction. The second elastic part 45b connects the first flat plate part 44a and the second flat plate part 44b in the X direction. The third elastic part 45c connects the second flat plate part 44b and the third flat plate part 44c in the Y direction. The fourth elastic part 45d connects the third flat plate part 44c and the fourth flat plate part 44d in the X direction. The shape of the four elastic parts 45 may be, for example, a semi-cylindrical shape which is convex along a projection direction of each projecting part 42.

In this way, in a bus bar module 1, the number of projecting parts 42 may be more than one. The cover body 41 may have the plurality of flat plate parts 44 which are arranged in the planar direction and support the projecting parts 42 individually, and the plurality of elastic parts 45 each of which connects two adjacent flat plate parts 44.

According to the bus bar module 1, since each projecting part 42 is appropriately displaced in response to a surface shape of a bus bar 10 in contact with each other, the cover body 41 follows the positional variation of the bus bar 10, and normal mounting of a cover 40 to a housing part 30 can be realized at all times.

Further, in the present embodiment, the second elastic part 45b and the fourth elastic part 45d are disposed so as to be most distant from each other in the Y direction. As a result, in the cover body 41, a through space equivalent to the through hole 41e in the second example of the bus bar case 20 is disposed, and therefore the same effect as that in the second example can be achieved in the third example of the bus bar case 20.

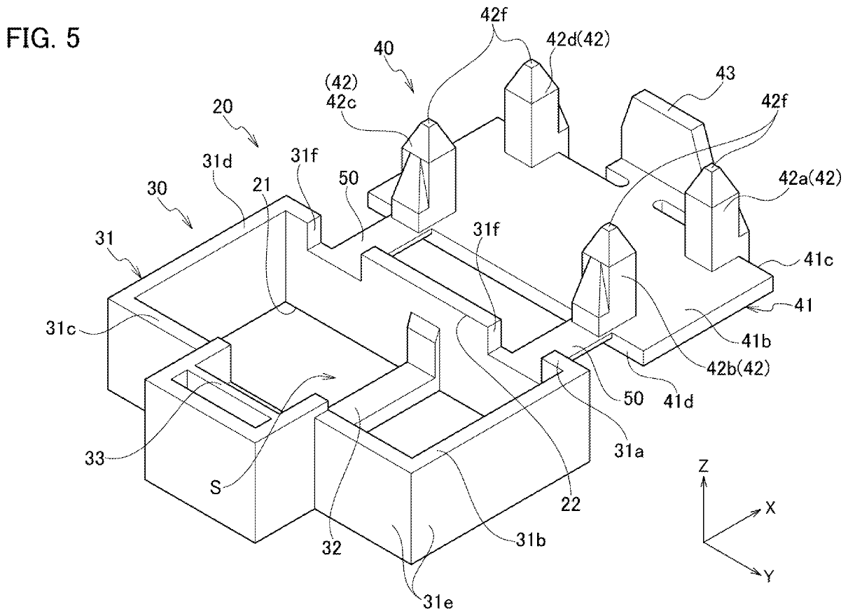

FIG. 5 is a perspective view illustrating a fourth example of a bus bar case 20. In the bus bar case 20 according to the fourth example, the same parts as those of the bus bar case 20 according to the first example illustrated in FIG. 2 are denoted by the same reference numerals, and a description thereof will be omitted.

In the first example of the bus bar case 20, the projecting parts 42 have been exemplified of which an overall shape is prismatic and which have the curved tip parts 42e. However, the shape of projecting parts 42 is not limited thereto. The overall shape of projecting parts 42 may be cylindrical, for example. In addition, a tip of each projecting part 42 may be a protrusion having an arbitrarily shape such as each square pyramidal part 42f illustrated in FIG. 5.

Further, in a bus bar module 1, a cover body 41 may have a locking part 43 at an end edge of the cover body 41. A housing part 30 may have a locked part 33 which is disposed on an outer surface 31e side of a side wall part 31 and engages with the locking part 43 when a cover 40 is mounted to the housing part 30.

In the above description with reference to each drawing, the end edge of the cover body 41 to which the locking part 43 is disposed is the first end edge 41c. Meanwhile, a portion of the side wall part 31 of the housing part 30 to which the locked part 33 is disposed is on the outer surface 31e side of the third side wall 31c.

According to the bus bar module 1, the locking part 43 and the locked part 33, functioning as locking mechanisms when the cover 40 is mounted to the housing part 30, are not inside the housing part 30, that is, not in a housing space S. Therefore, the large housing space S can be maintained as one of structures for reducing portions that can interfere when a terminal such as a positive electrode terminal 101 is connected to a bus bar 10 by means of bolt fastening or the like.

Further, in the bus bar module 1, the bus bar case 20 may have deformable plate-like hinge parts 50. One end of each hinge part 50 may be continuous with the outer surface 31e of the side wall part 31, and the other end opposite to the one end of each hinge part 50 may be continuous with an end edge of the cover body 41.

In the above description with reference to each drawing, the outer surface 31e of the side wall part 31 continuous with one end of each hinge part 50 is the outer surface 31e of the first side wall 31a. Meanwhile, the end edge of the cover body 41 continuous with the other end of each hinge part 50 is the second end edge 41d.

According to the bus bar module 1, the housing part 30 and the cover 40 of the bus bar case 20 are integrated via the hinge parts 50. Therefore, the entire bus bar case 20 can be manufactured by performing a simple process, for example, by performing injection molding, and the number of parts constituting the bus bar module 1 can be reduced, which can be advantageous for handling during an operation.

It is not an essential requirement that the housing part 30 and the cover 40 of the bus bar case 20 are integrated via the hinge part 50, and the housing part 30 and the cover 40 may be separate members without the bus bar case 20 having the hinge parts 50.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A bus bar module that electrically connects a first single battery having a positive electrode terminal and a negative electrode terminal as a pair of terminals and a second single battery having a positive electrode terminal and a negative electrode terminal as a pair of terminals, the bus bar module comprising:
a bus bar that connects one of the pair of the terminals of the first single battery and one of the pair of the terminals of the second single battery, the one of the pair of the terminals of the first single battery and the one of the pair of the terminals of the second single battery projecting in parallel with each other; and
a bus bar case having insulating properties that includes a housing part which houses the bus bar and a cover which is mounted to the housing part, wherein the housing part includes a side wall part having a frame shape that surrounds the bus bar from a direction perpendicular to a connection direction of the terminals to the bus bar, and a support part that supports the bus bar from a side of a first opening facing the first single battery or the second single battery in the side wall part, and
the cover includes a cover body that covers a second opening opposite to the first opening in the side wall part, and a projecting part that projects from the cover body toward the first opening and contacts the bus bar.

2. The bus bar module according to claim 1, wherein
the cover body includes a through hole.

3. The bus bar module according to claim 1, wherein
the projecting part is provided in plurality, and
the cover body includes a plurality of flat plate parts that are arranged in a planar direction and individually support the projecting parts, and a plurality of elastic parts that connect two adjacent flat plate parts of the flat plate parts.

4. The bus bar module according to claim 1, wherein
the cover body includes a locking part at an end edge of the cover body, and
the housing part includes a locked part that is disposed on a side of an outer surface of the side wall part and engages with the locking part when the cover is mounted to the housing part.

5. The bus bar module according to claim 1, wherein
the bus bar case includes a hinge part that is deformable and has a plate shape,
one end of the hinge part is continuous with an outer surface of the side wall part, and
the other end of the hinge part opposite to the one end is continuous with an end edge of the cover body.
